(19) United States
(12) Patent Application Publication
(10) Pub. No.: US 2023/0158399 A1
(43) Pub. Date: May 25, 2023

(54) A VIRTUAL REALITY OR AUGMENTED REALITY ATTACHMENT SYSTEM

(71) Applicant: Oleksiy ANDORIYCHENKO, Berlin (DE)

(72) Inventor: Oleksiy ANDRIYCHENKO, Berlin (DE)

(21) Appl. No.: 17/921,556

(22) PCT Filed: Apr. 28, 2021
(86) PCT No.: PCT/IB2021/053520

§ 371 Date: Oct. 26, 2022

Related U.S. Application Data
(60) Provisional application No. 63/016,761, filed on Apr. 28, 2020.

(51) Int. Cl. A63F 13/24; A63F 13/26; A63F 13/837; A63F 13/98

(52) U.S. Cl. CPC A63F 13/24; A63F 13/26; A63F 13/837; A63F 13/98; A63F 2300/8082

(57) ABSTRACT

A video game attachment system compatible with traditional, AR, and/or VR content, comprises a fixator to receive a display device, a first attachment assembly coupling the fixator to a physical controller object such as a toy gun, an actuation registration device, a registrator, and a second attachment assembly coupling the registrator to the physical controller object. A fixator adjustable receiving portion accommodates different display device dimensions. The first attachment assembly removably couples a fixator mounting portion to the physical controller object, at one of a plurality of different locations along a given dimension of the physical controller object. The actuation registration device is removably affixed to an actuator of the physical controller object. The registrator comprises a wireless transmitter and battery. In response to the actuation registration device being moved within a predetermined distance of the registrator, the registrator generates and wirelessly transmits an actuation signal to the display device.

### FIELD OF TECHNOLOGY

The present disclosure relates generally to a controller for a video game system, including virtual reality (VR) and/or augmented reality (AR) gaming systems, and more specifically relates to an attachment system for utilizing non-conventional controllers in a video gaming system.

### BACKGROUND

Current video game (including augmented and virtual reality video game) controllers are designed and manufactured for specific use with gaming systems. That is, current video game (including augmented and virtual reality video game) controllers are plastic molded with the necessary buttons/triggers and connecting mechanisms (e.g., Bluetooth, short range wireless, etc.) to operate with a video game system.

In a first person shooter video game, the controller is any physical object, commonly a gun. Toy guns, including Nerf guns, rifles, blasters, bows, and crossbows, are prevalent in toy stores and houses around the world. Accordingly, it would be desirable to provide a controller system having the capability to render these numerous existing toy guns compatible with a gaming system, in lieu of or in addition to the purpose-built controllers (gun-like or otherwise) that are required in conventional solutions. For example, according to an aspect of the disclosure, a physical object such as a toy gun may be equipped with an attachment system that may optionally include sensors, for connection with a gaming system to control virtual and/or augmented reality games, video games, computer games, and/or mobile games, etc. According to a further aspect of the disclosure, the optional sensors can be placed anywhere in the attachment system and are used to more precisely track the position of the physical object and improve the game experience.

In addition to first person shooter video games, other games using physical objects as a basis for controller design and/or corresponding user input mechanic(s), can include (but is not limited to) racing/driving games using steering wheels, sports games (baseball, golf, hockey, etc.) using mallets/clubs/bats, fighting/adventure games using stand-ins for swords or other melee weapons, etc. As such, aspects of the present disclosure further contemplate that one or more embodiments of the presently disclosed attachment system(s) may also be affixed to these physical objects, as well as others.

### BRIEF DESCRIPTION OF THE DRAWINGS

In order to describe the manner in which the features of the disclosure can be obtained, a more particular description of the principles briefly described above will be rendered by reference to specific examples thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIGS. 1A-1L illustrate various views and configurations of an example attachment system, in accordance with an example embodiment of the present disclosure;

FIGS. 2A-2M illustrate various views and configurations of an example attachment system, in accordance with an example embodiment of the present disclosure;

FIGS. 3A-3D illustrate various views and configurations of an example attachment system, in accordance with an example embodiment of the present disclosure;

FIGS. 4A-4D illustrate various views and configurations of an example attachment system, in accordance with an example embodiment of the present disclosure;

FIGS. 5A-5D illustrate various views and configurations of an example attachment system, in accordance with an example embodiment of the present disclosure;

FIGS. 6A-6F illustrate an example glove attachment system, in accordance with an example embodiment of the present disclosure; and

FIGS. 7A-7D illustrate example trigger systems, in accordance with an example embodiment of the present disclosure.

### DETAILED DESCRIPTION

Various examples of the disclosure are discussed in detail below. While specific implementations are discussed, it should be understood that this is done for illustration purposes only. A person skilled in the relevant art will recognize that other components and configurations can be used without parting from the scope of the disclosure.

According to an aspect of the present disclosure, disclosed herein is a video game (including virtual reality (VR) and/or augmented reality (AR)) attachment system wherein a physical object is configured with a removably attachable and detachable display device (e.g., smartphone, etc.) and actuation sensor (e.g., in the example of a toy gun, the actuation sensor could be provided as a trigger sensor). By removably attaching the display device and actuation sensor to the physical object, the presently disclosed attachment system permits a user to interact with a VR, AR, and other video games, while using an existing physical object as a controller device. Note that the physical object is also referred to herein as a “controller device” or “controller device object”. In some embodiments, the controller device object can include a discrete actuating element, such as the trigger of a toy gun. In some embodiments, the actuating element of the controller device object can be given by the manner in which a user moves, handles, or interacts with the controller device object, such as in the case of a user swinging a baseball bat or golf club.

In some embodiments, a display device such as a smartphone is removably coupled to a fixator, where the fixator provides support for the display device and couples the display device to the controller device object. A mechanical fixator can further include a knob permitting rotation or adjustment of the display device to a final or fixed position desired by the user. In particular, the display device and fixator can be removably affixed to a controller device object, such as a toy gun, rifle, blaster, bow, or crossbow with a trigger, by way of an attachment assembly. In some embodiments, the fixator (and attachment assembly) can be affixed to the controller device object in a more permanent fashion, while the display device is quickly and easily removable from the fixator and controller device object combination. In this manner, users can install the fixator and attachment assembly onto a controller device object such as a toy gun only once, or a limited number of times, while being able to quickly attach and detach their smartphone display device from the fixator at the beginning and end, respectively, of a video game session.

In some examples, the display device can itself implement or provide a video game system or video game system capability, such that the display device is capable of executing one or more of: augmented reality (AR) games, virtual reality (VR) games, general video games, computer games, and mobile games, among others. In some examples, the display device can be remotely or wirelessly connected to a game system, e.g., over the Internet or over a local connection provided via Bluetooth or other short-range wireless protocols such as Wi-Fi Direct and/or NFC. In some examples, the display device can be located remote from the controller device object (e.g., when the display device is provided as a television, etc.).

As mentioned previously, in some embodiments the controller device object may be any physical object with an actuating mechanism suitable for use as a user input mechanism—a common example of one such physical object with an actuating mechanism would be a toy gun with a trigger, the actuation of which can be sensed and used to generate one or more user inputs. In some embodiments, the actuating mechanism for a controller device object can be provided by the manner in which a user holds, moves, or otherwise physically interacts with the controller device object. For example, aspects of the present disclosure contemplate controller device objects that include objects such as baseball bats, tennis rackets, and other objects that do not—when viewed in isolation—possess a standalone actuating mechanism. Instead, the actuating mechanism is provided for these controller device objects by the manner in which they are held, moved, swung, etc., by the user. In other words, the actuating mechanism of a baseball bat is provided by the specific movement of the bat in a user's hands, rather than by a dedicated actuating component integrated with the baseball bat.

The attachment assembly can be positioned to wrap around a body portion of the controller device object in order to hold the display device and fixator in a fixed position on top of the controller device object. For example, the attachment assembly can, in some embodiments, be provided as a fabric belt, a Velcro strap, a webbing, etc. As will be discussed in greater depth below, the attachment assembly can further include a battery, a Bluetooth (or Wi-Fi Direct, etc.) transmitter, and a registrator, wherein the attachment assembly is securely and removably attached to the controller device object in a position near the actuator by use of Velcro, for example. In this manner, a user can view and interact with a virtual or augmented reality program rendered on a screen of the display device while also holding the controller device object in an intended position.

In some embodiments, the display device can track the position of the controller device object and reflect the tracked position in an augmented reality scene rendered on a screen of the display device. For example, the display device might be used to provide tracking and sensing capabilities in the context of augmented reality games and/or experiences, although this example is for purposes of illustration and not intended to be construed as limiting. Similarly, one or more updates to the tracked position can be reflected in corresponding updated to the augmented reality scene(s) rendered on the screen of the display device.

In some embodiments, a tracker component or module can be coupled to or included within the attachment system, where the tracker comprises one or more sensors for tracking the physical location of the user and/or the position of the controller device object. For example, the tracker component/module might be used to provide tracking and sensing capabilities in the context of virtual reality games and/or experiences, although this example is for purposes of illustration and not to be construed as limiting. In some embodiments, the tracker can be used to provide primary tracking and sensing capabilities, in lieu of those provided by an attached display device. In some embodiments, the tracker can be used to provide secondary or additional tracking and sensing capabilities, i.e., in conjunction or combination with those provided by an attached display device. For example, the tracker can include one or more accelerometers, Hall Effect sensors, pressure sensors, cameras, and/or other sensors known in the art. These additional sensors may be placed anywhere in the attachment system and can be used to more precisely track the position of the controller device object and improve the game experience. For example, data from a camera or other sensor located on or coupled to the fixator and/or attachment system can be used to improve the tracking of the controller device object and thus the accuracy of the VR and/or AR video game or experience delivered to the user. In this manner, tracking can be improved for both the scenario in which a display device/smartphone is mounted on the physical controller device object, and the scenario in which a tracker, comprising secondary sensors in addition to the primary sensors of the attachment system, is mounted on the physical controller device object.

In some embodiments, the attachment assembly includes a registrator connected to a push button, where the push button is removably affixed by magnets and/or wired to the actuator (or trigger) of an actuating controller device object. When the actuator and push button combination is actuated by the user, the registrator detects a signal generated by the push button and, in response, sends a signal (e.g., using Bluetooth, Wi-Fi Direct, short range wireless, wired connection, etc.) to the display device indicating that an actuation occurred. Alternatively, the attachment assembly may employ Hall sensors, pressure sensors, or push buttons to detect an actuation. The attachment assembly (which in some embodiments can be provided as another fixator) can include a registrator, battery, and Bluetooth (or Wi-Fi Direct, etc.) transmitter. In such embodiments, the attachment assembly can be removably attached to a handle of the actuating controller device, in a position near the actuator, e.g., by use of Velcro or other attachment means. A trigger push button is securely affixed by magnets (i.e., removably) to the actuator or trigger of the actuating controller device. When the actuator with the push button is pulled or otherwise actuated by the user, the registrator detects the signal from the push button and sends a signal (e.g., using Bluetooth, Direct, short range wireless, wired connection, etc.) to the display device to indicate such. Alternatively or additionally, the attachment assembly may employ Hall sensors, pressure sensors, or push buttons to detect that the trigger has been pulled, or more generally that the actuation component of the controller device object has been actuated.

In some embodiments, a display device is removably coupled/affixed to a fixator using a multi-adapter to provide support for the display device. The base of the multi-adapter is affixed to the top of the controller device object, using for example, double-sided tape, Velcro, a tab or friction fit mechanism, or any other suitable method. The top portion of then multi-adapter slides or otherwise couples with the affixed base portion of the multi-adapter, such that the top portion of the multi-adapter allows a user to securely and removably attach the display device and fixator on top of the controller device object. In this manner, the user can view and interact with a virtual or augmented reality program on the display device screen while holding (and using/actuating) the actuating controller device in one or more intended or desired positions.

In some embodiments, a display device is removably coupled/affixed to a fixator (for providing support and adjustable positioning of the display device) and the display device+fixator combination is then further coupled to the controller device object via an adjustable bracket, strap or webbing. The adjustable bracket (or strap, webbing, etc.) is encircled around the controller device object and tightened to securely and removably couple the display device and fixator to the controller device object so that a user can view and interact with a virtual or augmented reality program on the display device screen while holding the controller device object in its intended position.

In some embodiments, a display device is removably coupled to a fixator to provide support and user-adjustable positioning for the display device. The combined display device and fixator are then further coupled to an attachment assembly (e.g., a mechanical mount) having a size adjustment knob for removably coupling the display device and fixator combination to controller device objects of various sizes, shapes, and/or diameters. The attachment assembly or mechanical mount is then removably affixed to the controller device object according to one or more of the configurations described above.

In some embodiments, a display device is removably coupled to a rigid basement support to provide support and user-adjustable positioning for the display device. The rigid basement support is removably affixed to an attachment assembly (e.g. adjustable fabric fixation mount) that wraps around an actuating controller device, such as a toy gun, rifle, blaster, how, or crossbow with a trigger, such that the display device and rigid basement support are coupled to the actuating controller device via the attachment assembly (e.g. adjustable fabric fixation mount).

In some embodiments, a display device is removably coupled to a metal plate support to provide support and user-adjustable positioning for the display device. The metal plate support is removably affixed to an attachment assembly (e.g. adjustable fabric fixation mount) that wraps around an actuating controller device, such as a toy gun, rifle, blaster, bow, or crossbow with a trigger, to securely fasten the display device and metal plate support to the actuating controller device via the attachment assembly (e.g. adjustable fabric fixation mount).

As used herein, the terms “controller device,” “controller device object,” and “actuating controller device” can refer to any physical object with an actuatable portion) that may be held, carried, or actuated by a user, and may also refer to any physical object (with or without an actuatable portion) that may itself be held, carried, and actuated by a user. Examples of such controller device objects include, but are not limited to, toy guns, self-made wooden guns, airsoft guns, water guns, bows, crossbows, Nerf guns, and/or assembled LEGOs.

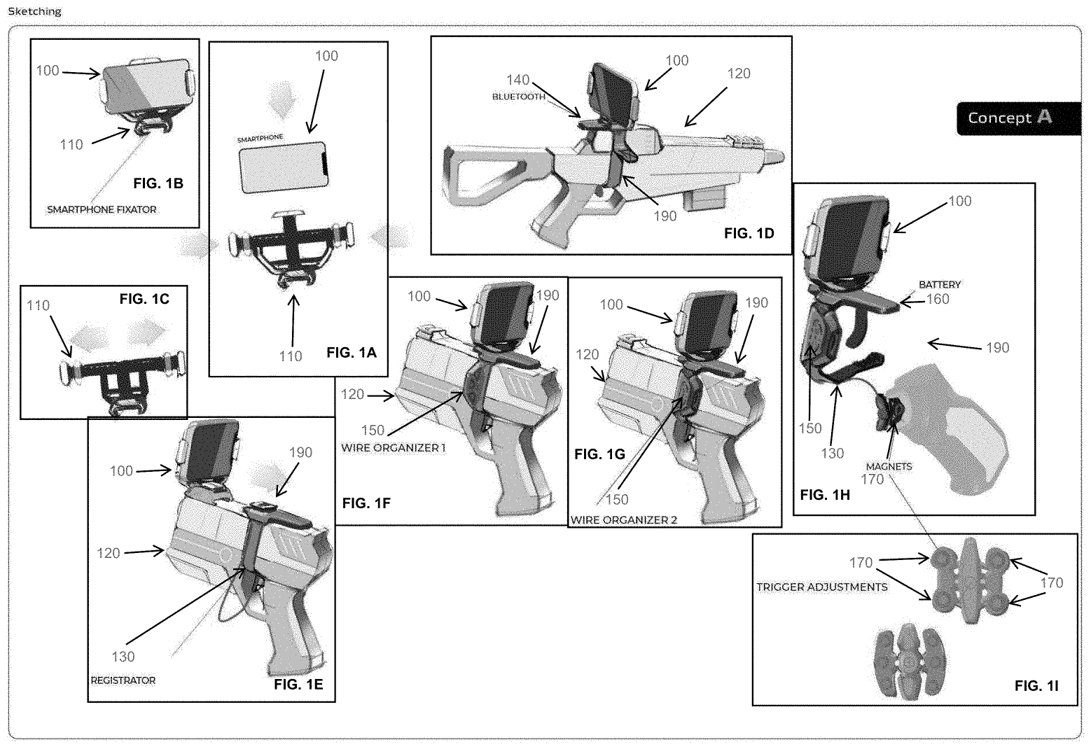

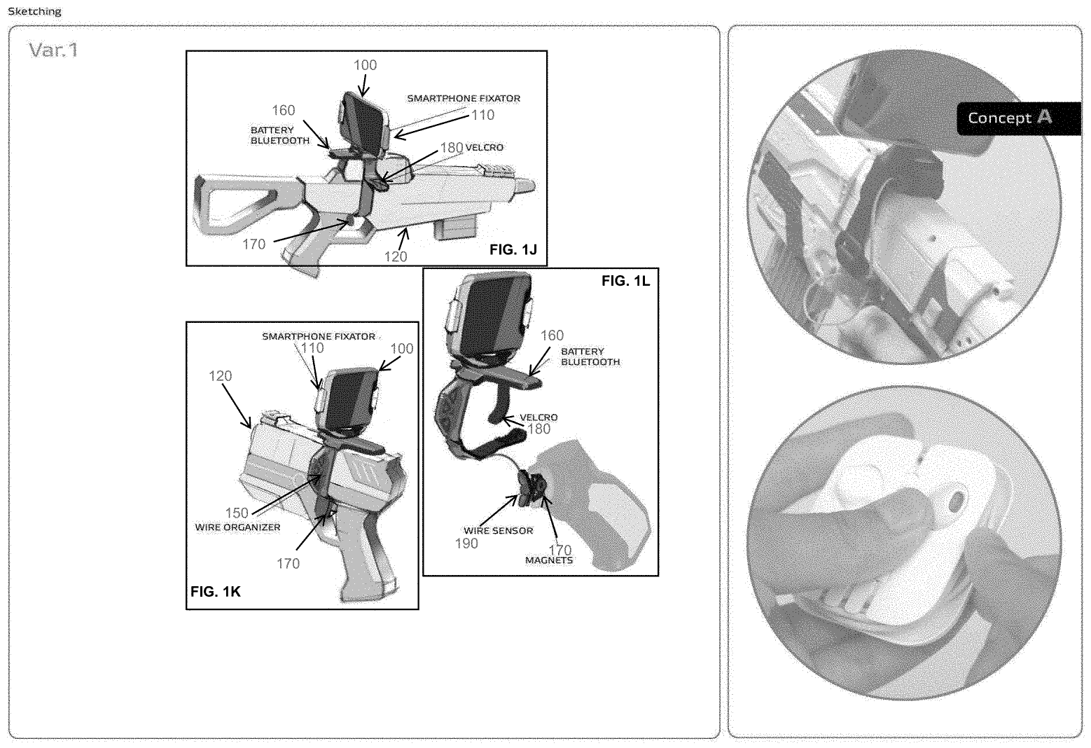

The disclosure turns now to FIGS. 1A-1L, which illustrate an example embodiment of the presently disclosed video game (including virtual reality (VR) and/or augmented reality (AR)) attachment system disclosed herein. A smartphone 100 is removably coupled to fixator 110. The combination of smartphone 100 and fixator 110 are then removably coupled to controller device object 120 via a controller attachment assembly 190, as shown, for example, in FIG. 1D.

As seen in FIGS. 1D-H and 1K, controller attachment assembly 190 comprises a battery 160, a Bluetooth (or Wi-Fi Direct, etc.) transmitter 140, a registrator 130, and a wire organizer 150. The controller attachment assembly 190 can be made of a flexible material such as fabric and can include a Velcro material 180 (as illustrated in FIG. 1L). In addition to being removably coupled to fixator 110 (as described above), the controller attachment assembly 190 is further connected to a push button 170 via a wire as shown in FIG. 1H. The push button 170 is removably affixed by magnets to the actuator (or trigger) of the actuating controller device, as seen in FIG. 1I, which illustrates an example embodiment of the trigger push button 170. In FIG. 1I, a trigger or other actuation component of the controller device object is placed in contact with the central portion of trigger push button 170, and then the distal edges of trigger push button 170 are wrapped around the outer surface of the trigger and affixed by bringing the magnets along each distal edge into contact with the respective magnets on the opposite distal edge. Accordingly, the controller attachment assembly 190 is removably coupled to controller device object 120 and push button 170 is removably affixed by magnets to the actuator of controller device object 120 in the manner illustrated in FIG. 1J.

The above system works together with a virtual or augmented reality program executed and displayed on the smartphone device (or executed remotely and displayed on the smartphone device, and/or executed remotely and displayed on a screen or display device other than that associated with the smartphone, as described above). Such a program may be a game, for example, wherein the smartphone screen displays a real-world camera view with virtual objects superimposed for a user to target or otherwise interact with. In other examples, the game is a virtual or augmented reality game and the display device is a virtual reality headset. In operation, when a user actuates the actuatable portion of the controller device object 120, the magnet 170 that is removably affixed to the actuator is drawn closer to the registrator 130 of the controller attachment assembly 190. The registrator 130 senses that the magnet 170 has come within a predetermined distance of the registrator 130, thereby indicating that the user has actuated the actuatable portion. In response, transmitter 140 sends a signal to the smartphone 100 indicating that the user has “pulled the trigger” (actuated the actuatable portion) of the actuating controller device object 120. The signal is interpreted by the virtual or augmented reality program to render a virtual response on the display screen of smartphone 100. Additionally, as described previously the controller attachment assembly 190 may itself optionally comprise one or more accelerometers, Hall sensors, pressure sensors, cameras, and/or other sensors known in the art in order to track the physical location of the user and the position of the controller device. These additional sensors may be placed anywhere in the attachment system and can be used to more precisely track the position of the physical object and improve the game experience. For example, data from the camera or other sensor located within the fixator is used to improve the tracking of the physical object. Tracking can be improved in this way for both the case when a display device (such as a smartphone) is mounted on the physical object or when a tracker (comprising sensors in addition to the sensors of the attachment system) is mounted on the physical controller device object. While controller device 120 illustrated in FIGS. 1A-L can be a toy gun, other types of controller devices 120 can further include, without limitation, toy steering wheels with actuators for gas, brakes, etc.; toy mallets, clubs, or other sporting accessories with actuators for certain types of hits/shots; etc.

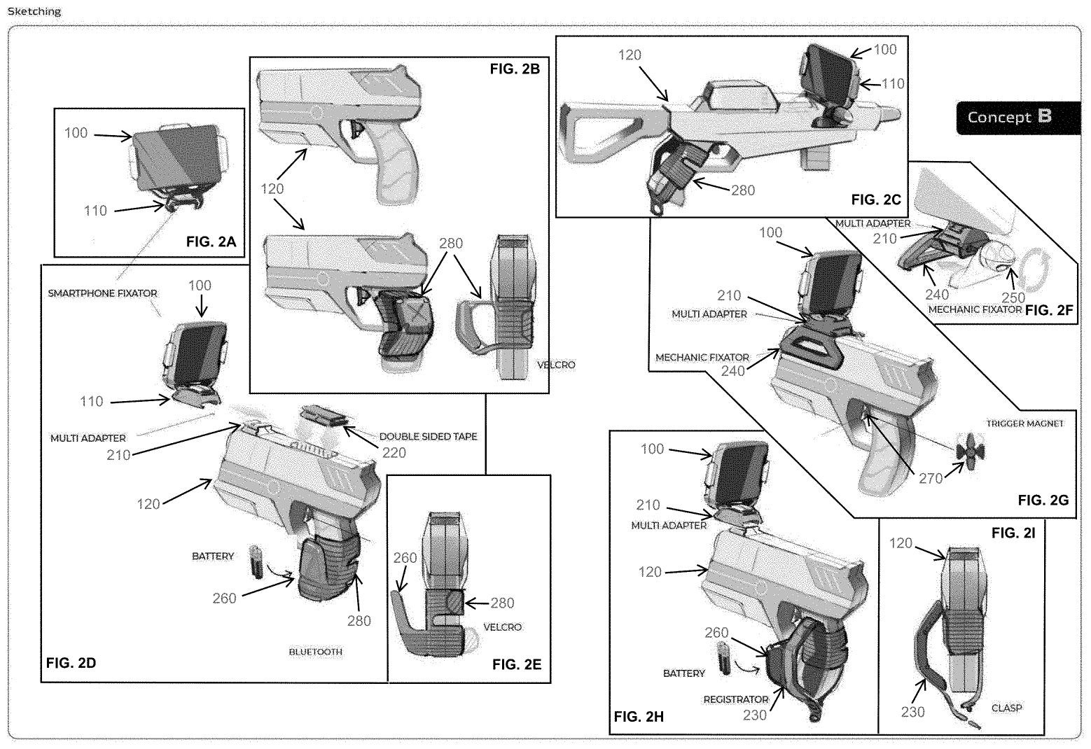

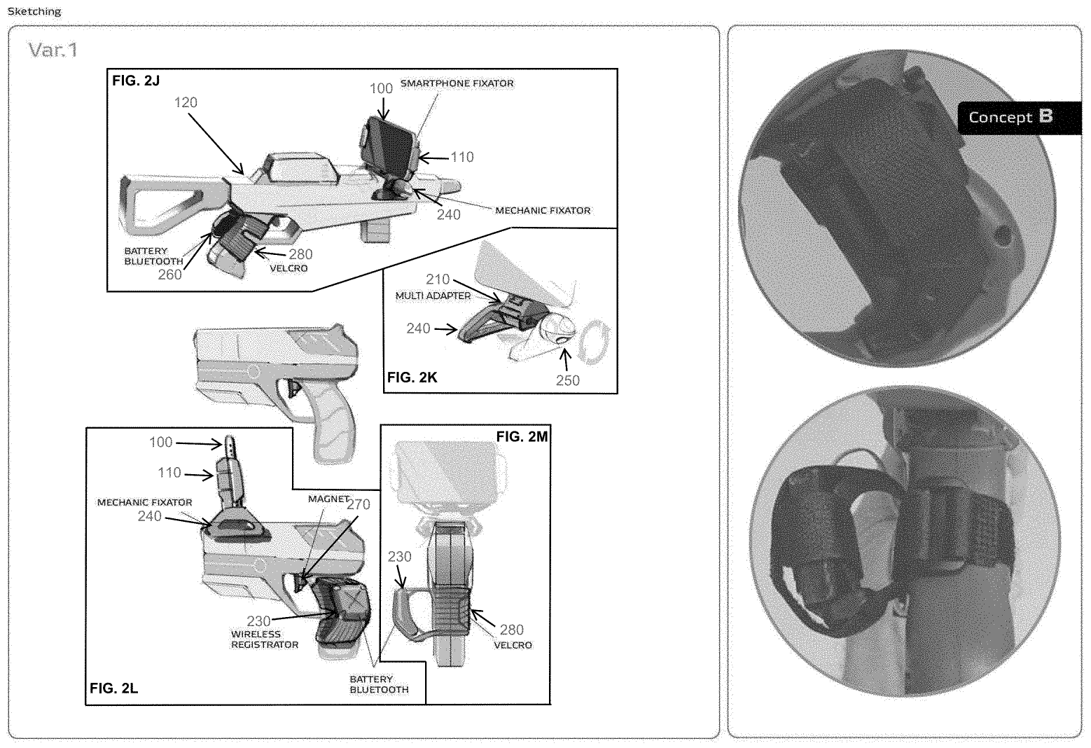

FIGS. 2A-M illustrate an example embodiment of the presently disclosed video game (including virtual reality (VR) or augmented reality (AR) video games) attachment system described herein. A multi-adapter comprising a top 210 and a base 220 is illustrated in FIGS. 2D and 2H, for example. Smartphone 100 is removably coupled to the multi-adapter top 210, while the multi-adapter base 220 is removably affixed to the top of the actuating controller device 120 by way of double-sided tape, for example. This arrangement permits the smartphone 100 and multi-adapter top 210 to be removably coupled to the multi-adapter base 220 and actuating controller device 120 as shown in FIG. 2H. Mechanical fixator 240 and adjuster 250 can be used to offer greater stability to the coupling arrangement between multi-adapter top 210 and the connected controller device object 120, e.g., as shown in FIGS. 2F, 2G, and 2K.

A Velcro attachment assembly 280 comprises a battery 260, a transmitter, and a registrator 230, as shown in FIGS. 2E, 2I, and 2H. Velcro attachment assembly 280 is removably attached to the controller device object 120 in a location near the actuator as illustrated in FIGS. 2B, 2D, and 2E. A magnet 270 is removably affixed to the actuator of the controller device object 120, e.g., as illustrated in FIG. 2G.

As described with reference to the embodiments discussed above, the system of FIGS. 2A-M can work together with a virtual or augmented reality program executed and displayed on the smartphone device. When a user actuates the actuator of controller device object 120, the magnet 270 that is removably affixed to the actuator is drawn closer to the registrator 230 of the control actuator assembly 280 (e.g., a Velcro attachment assembly). The registrator 230 senses that the magnet 270 has come within a predetermined distance of the registrator 230, thereby indicating that the user has actuated the actuator. For example, in order to sense the presence of one or of magnets 270, registrator 230 can comprise one or more Hall Effect sensors or other sensors suitable for detecting the presence of a magnetic field, or more specifically, changes in a magnetic field at the location of the registrator 230. In response, the transmitter sends a signal to the smartphone 100 indicating that the user has “pulled the trigger” (actuated the actuatable portion) of the controller device object 120. The signal is interpreted by the virtual or augmented reality program to render a corresponding virtual response on the display screen of smartphone 100. Additionally, the controller attachment assembly 280 may optionally comprise accelerometers, Hall sensors, pressure sensors, cameras, and other sensors known in the art in order to track the physical location of the user and the position of the controller device. These additional sensors may be placed anywhere in the attachment system and can be used to more precisely track the position of the physical object and improve the game experience.

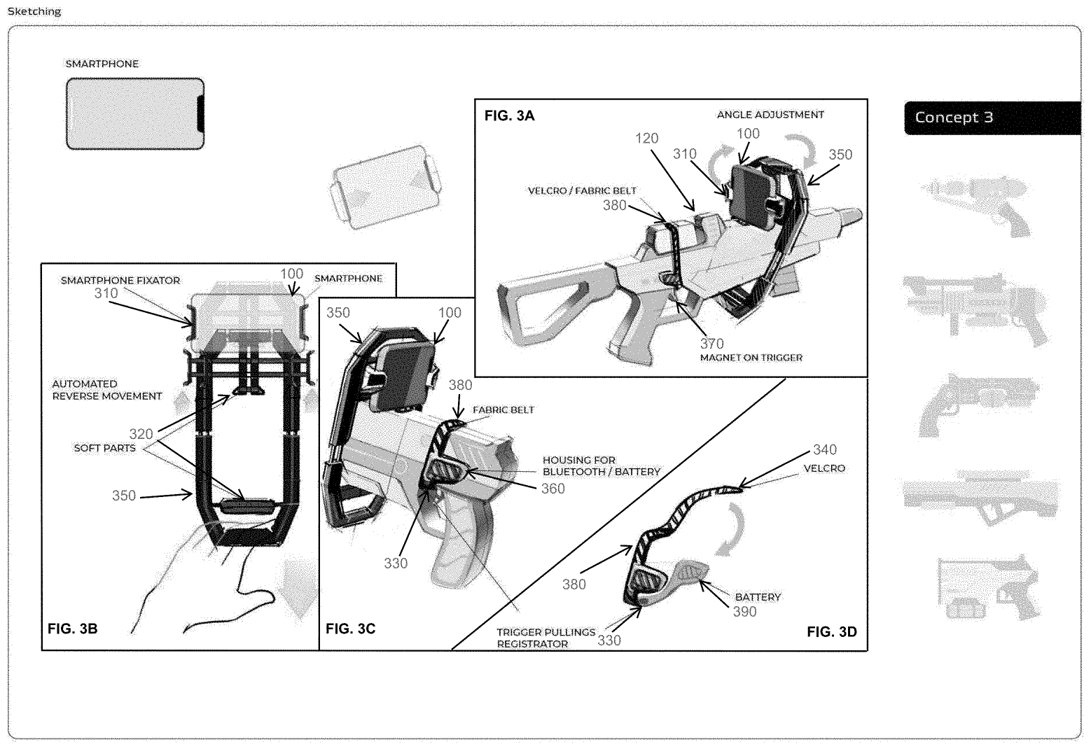

FIGS. 3A-D illustrate an example embodiment of the presently disclosed video game (including virtual reality (VR) or augmented reality (AR) video games) attachment system. Display device 100 is removably coupled to fixator 310 and further removably coupled to adjustable bracket 350 as illustrated in FIG. 3B. Adjustable bracket 350 comprises soft parts 320 to contact the controller device object 120 and thereby permits movement as indicated by the arrows in FIG. 3B. The adjustable bracket 350 coupled to smartphone fixator 310 and smartphone 100 is positioned to encompass controller device object 120 in the manner illustrated in FIG. 3A. Attachment assembly 380 (e.g., a fabric belt assembly) comprises a battery 390, a registrator 330, and a transmitter 360 as shown in FIGS. 3C and 3D. The attachment assembly 380 (e.g., a fabric belt assembly) is removably affixed to the controller device object 120 at a position near the actuator of the controller device object 120, for example in the manner shown in FIG. 3D. A magnet 370 is removably affixed to the actuatable portion of the controller device object 120 as illustrated in FIG. 3A, in order to couple registrator 330 to the actuatable portion for generating actuation signals in response to a user actuating the trigger/actuatable portion of controller device object 120, as has been previously described above.

When a user actuates the actuatable portion of controller device object 120, the magnet 370 that is removably affixed to the actuatable portion is drawn closer to the registrator 330 of the adjustable bracket 350. The registrator 330 senses that the magnet 370 has come within a predetermined distance of the registrator 330, thereby indicating that the user has actuated the actuatable portion of controller device object 120. In response, the transmitter 360 sends a signal to the smartphone 100 indicating that the user has “pulled the trigger” (actuated the actuatable portion) of the controller device object 120. The signal is interpreted by the virtual or augmented reality program to render a virtual response on the display screen of smartphone 100. Additionally, the controller attachment assembly 380 may optionally comprise accelerometers, Hall sensors, pressure sensors, cameras, and other sensors known in the art in order to track the physical location of the user and the position of the controller device. These additional sensors may be placed anywhere in the attachment system and can be used to more precisely track the position of the physical object and improve the game experience. For example, data from the camera or other sensor located within the fixator is used to improve the tracking of the physical object. Tracking can be improved in this way for both the case when a display device (such as a smartphone) is mounted on the physical object or when a tracker (comprising sensors in addition to the sensors of the attachment system) is mounted on the physical device.

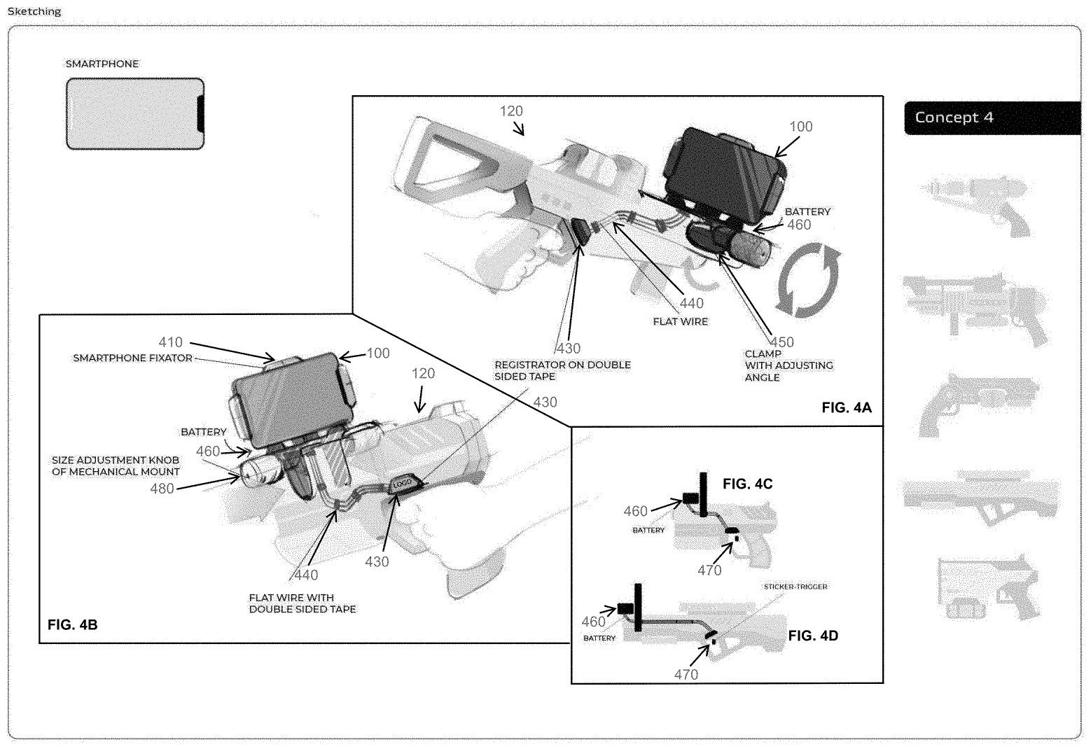

FIGS. 4A-D illustrate an example embodiment of the presently disclosed video game (including virtual reality (VR) or augmented reality (AR) video games) attachment system described herein. Display device 100 is removably coupled to fixator 410 and further removably coupled to an attachment assembly 450 (e.g., a mechanical mount) as illustrated in FIGS. 4A and 4B. The mechanical mount of attachment assembly 450 comprises a clamp with an adjusting angle, 450 as indicated in FIG. 4A, and in some embodiments further comprises a size adjustable knob 480 as indicated in FIG. 4B. Attachment assembly/mechanical mount 450 is removably coupled to controller device object 120 in the manner illustrated in FIGS. 4C and 4D. The attachment assembly/mechanical mount comprises a battery 460, a registrator 430 connected via flat wire 440 to the mechanical mount 450, and a Bluetooth (or Wi-Fi Direct, etc.) transmitter. Magnet 470 is removably affixed to the actuator of the actuating controller device 120 as shown in FIGS. 4C and 4D.

As described previously, when a user actuates the actuatable portion of controller device object 120, the magnet 470 that is removably affixed to the actuatable portion is drawn closer to the registrator 430 of the attachment assembly. The registrator 430 senses that the magnet 470 has come within a predetermined distance of the registrator 430, thereby indicating that the user has actuated the actuatable portion. In response, the transmitter sends a signal to the smartphone 100 indicating that the user has “pulled the trigger” (actuated the actuatable portion) of the controller device object 120. The signal is interpreted by the virtual or augmented reality program to render a virtual response on the display screen of smartphone 100.

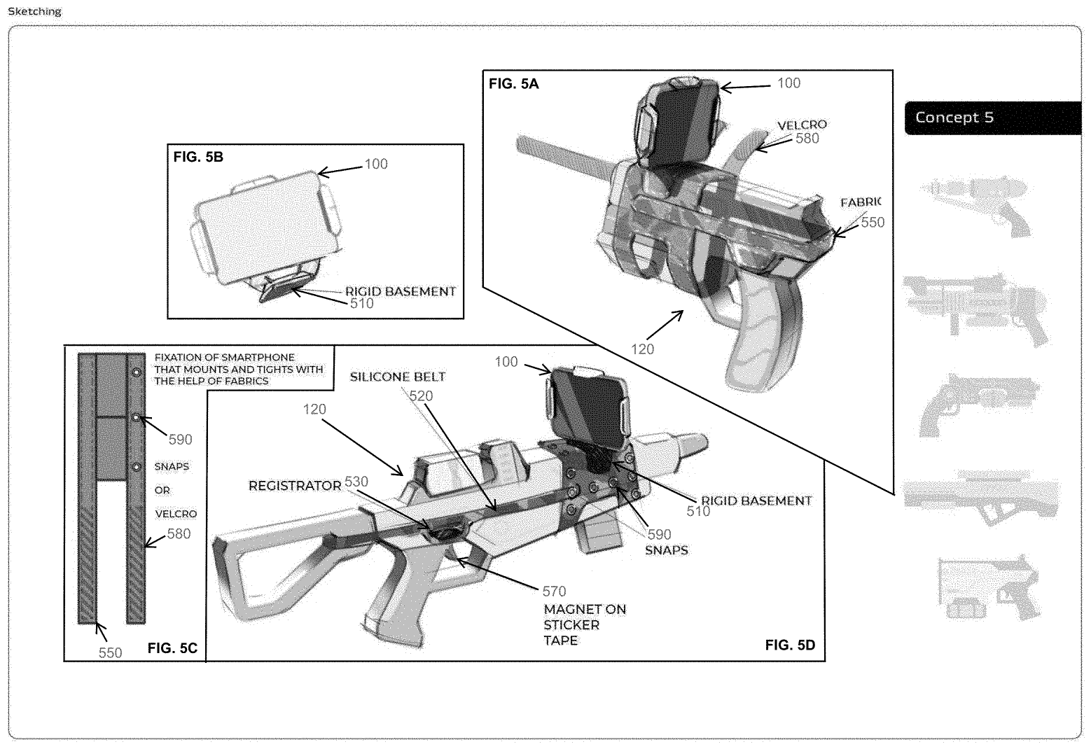

FIGS. 5A-5D illustrate an embodiment of the presently disclosed video game (including virtual reality (VR) or augmented reality (AR) video games) attachment system described herein. Display device 100 is removably coupled to a rigid basement 510 as shown in FIG. 5B, while FIG. 5C shows an attachment assembly 550 (e.g., an adjustable fabric fixation mount), which comprises either Velcro 580 or snaps 590. Attachment assembly 550 (e.g., an adjustable fabric fixation mount), which includes a registrator 530, is removably coupled to the smartphone 100 and the rigid bottom 510. Attachment assembly 550 is further removably affixed to the controller device object 120 in the manner shown in FIGS. 5A and 5D. Attachment assembly 550 (e.g., the adjustable fabric fixation mount) may further comprise a silicone belt 520 as shown in FIG. 5D. Additionally, one or more magnets 570 can be removably affixed to the actuator of the controller device object 120 as shown in FIG. 5D.

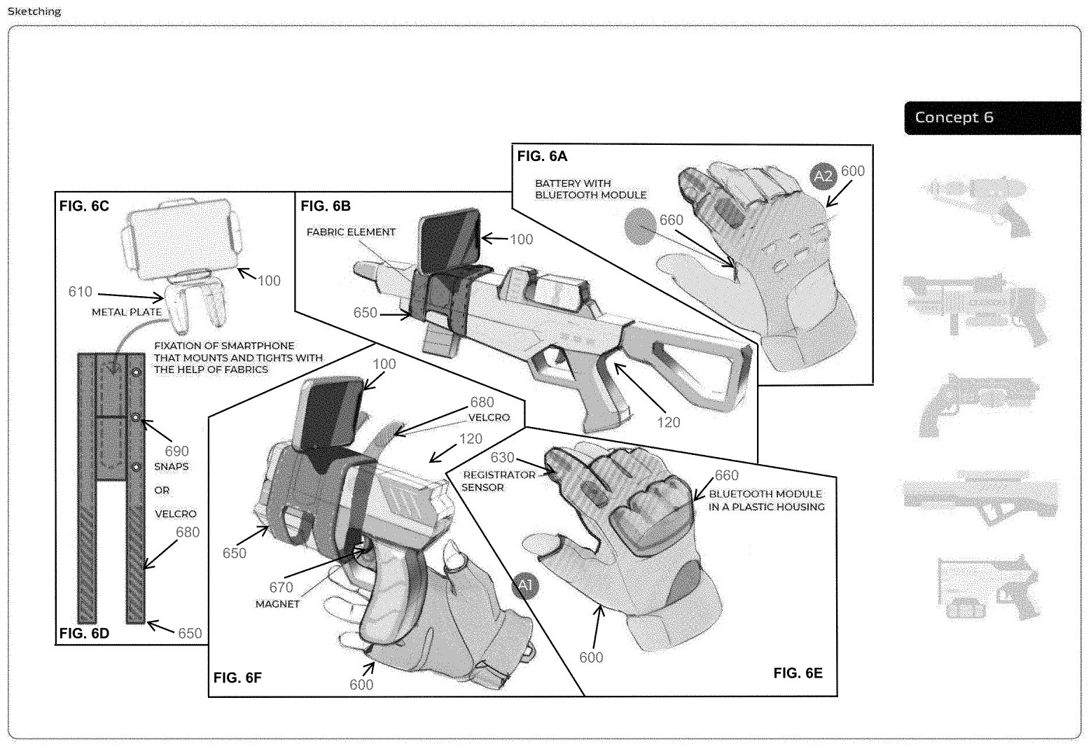

FIGS. 6A-E illustrate an example of a glove 600 that may be used with one or more aspects of the present disclosure, including but not limited to the system described above with regard to FIGS. 5A-D. The glove 600 comprises a battery with a Bluetooth (or Wi-Fi Direct, etc.) transmitter 660 and a registrator 630, as shown in FIGS. 6A and 6E. The registrator 630 comprises a force sensing resistor (FSR sensor) so that when a user actuates the actuatable portion of controller device object 120, the FSR sensor within the registrator 630 senses the change of force applied. In response, the transmitter sends a signal to the smartphone 100 indicating that the user has “pulled the trigger” (actuated the actuatable portion) of the controller device object 120. The signal is interpreted by the virtual or augmented reality program to render a virtual response on the display screen of smartphone 100.

FIGS. 6B, 6C, and 6F illustrate an attachment assembly 650 (e.g., an adjustable fabric fixation mount) that works with the glove 600 in substantially the same manner that the attachment assembly 550 works with glove 600. FIG. 6D shows the adjustable fabric fixation mount 650, which comprises either Velcro 680 or snaps 690. Attachment assembly 650 (e.g., an adjustable fabric fixation mount) is removably coupled to the smartphone 100 and a metal plate 610, and is further removably affixed to the controller device object 120 in the manner shown in FIGS. 6B and 6F. Magnet 670 is removably affixed to the actuator of the actuating controller device 120 as shown in FIG. 6F.

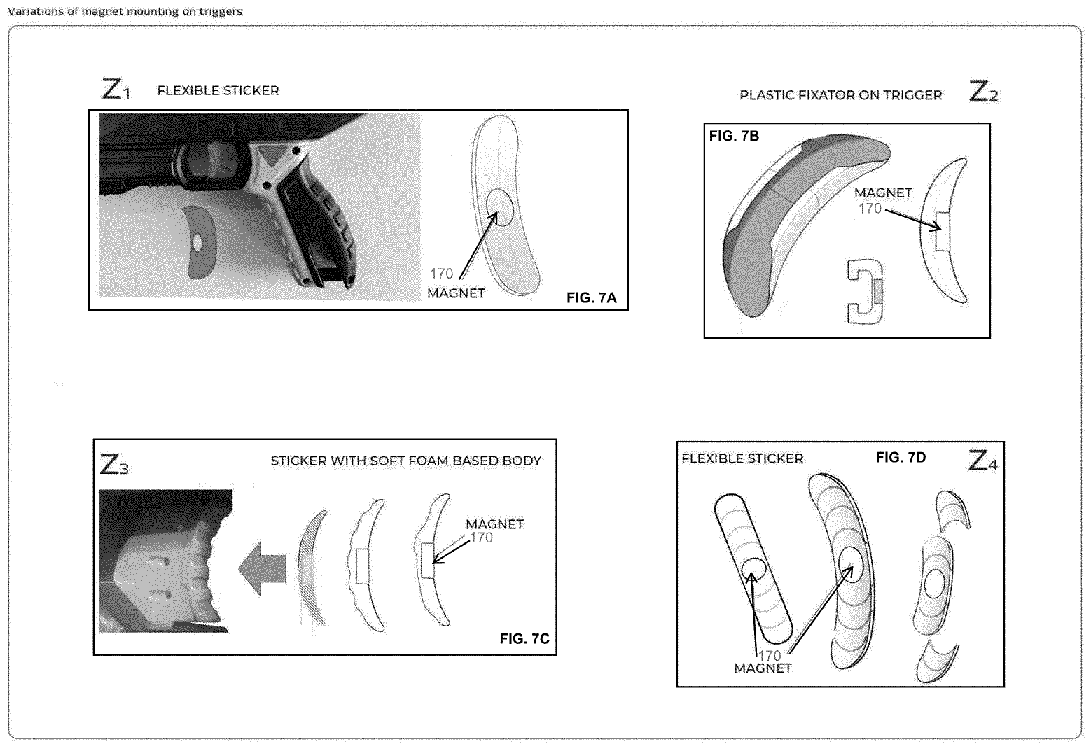

FIGS. 7A-D illustrate a trigger magnet 170. FIG. 7A illustrates the magnet 170 enclosed in a flexible sticker. FIG. 7B illustrates the magnet 170 enclosed in a plastic fixator. FIG. 7C illustrates the magnet 170 enclosed in a sticker with a soft foam-based body. FIG. 7D illustrates the magnet 170 enclosed in an alternate flexible sticker.

What is claimed is:

1. A video game attachment system comprising:
a fixator configured to removably receive a display device, the fixator comprising:
an adjustable receiving portion to accommodate different display device dimensions; and
a mounting portion coupled to the adjustable receiving portion;
a first attachment assembly configured to engage the mounting portion of the fixator and removably couple the fixator to a physical controller object, wherein the first attachment assembly comprises an adjustable attachment mechanism for coupling the fixator at a plurality of different locations along a given dimension of the physical controller object;
an actuation registration device removably affixed to an actuator of the physical controller object;
a registrator comprising a wireless transmitter and a battery, such that in response to the actuation registration device being moved within a predetermined distance of the registrator, the registrator is configured to generate and wirelessly transmit an actuation signal to the display device; and
a second attachment assembly configured to removably affix the registrator to the physical controller object.

2. The system of claim 1, wherein the second attachment assembly is configured to removably affix the registrator adjacent to the actuator of the physical controller object.

3. The system of claim 2, wherein:
the actuation registration device comprises one or more magnets removably affixed to the actuator of the physical controller object;
the registrator further comprises one or more Hall Effect sensors; and
the registrator is configured to generate the actuation signal based at least in part on the Hall Effect sensors outputting a sensed magnetic field value corresponding to the one or more magnets being moved within a predetermined distance of the Hall Effect sensors.

4. The system of claim 2, wherein the actuation registration device comprises a push button removably affixed to the actuator such that:
the push button remains in a fully extended state when the actuator is in a resting position; and
the push button is fully or partially depressed when the actuator is actuated away from the resting position, such that the registrator is configured to generate the actuation signal based at least in part on a detecting an energized circuit resulting from the partial or full depression of the push button.

5. The system of claim 2, wherein:
the actuation registration device comprises a pressure sensor removably affixed to the actuator such that the pressure sensor generates a variable magnitude pressure signal in response to actuation of the actuator; and
the registrator is configured to generate the actuation signal based on one or more of:
the generated pressure signal exceeding a first pressure threshold; or
the generated pressure signal exceeding a second pressure threshold for at least a predetermined amount of time, wherein the second pressure threshold is smaller than the first pressure threshold.

6. The system of claim 1, wherein the first attachment assembly and the second attachment assembly are provided as a single unitary attachment assembly.

7. The system of claim 6, wherein the single unitary attachment assembly comprises a flexible material for removably encircling a portion of the physical controller object, such that a continuous length of the flexible material engages the mounting portion of the fixator and additionally engages a receiving slot of the registrator, thereby removably affixing both the fixator and the registrator to the physical controller object.

8. The system of claim 7, wherein the continuous length of flexible material of the single unitary attachment assembly comprises one or more of a fabric belt, a Velcro strap, a webbing, or a double-sided adhesive.

9. The system of claim 1, wherein the first attachment assembly comprises a multi-adapter for engaging with fixator mounting portions of different sizes and geometries, the multi-adapter comprising:
a top portion for receiving and engaging the mounting portion of the fixator; and
a bottom portion configured to removably receive the top portion of the multi-adapter and couple to a desired location along the physical controller object.

10. The system of claim 9, wherein the bottom portion of the multi-adapter is coupled to the physical controller object via Velcro or a double-sided adhesive.

11. The system of claim 9, wherein:
the bottom portion of the multi-adapter comprises a mechanical clamp having first and second parallel arms, such that an outer surface of the physical controller object is positioned within a volume defined between the first and second parallel arms of the mechanical clamp: and
a distance between the first and second parallel arms is adjustable via a rotatable knob disposed on the mechanical clamp, such that the bottom portion of the multi-adapter is affixed to the physical controller object by a clamping force generated by reducing the distance between the first and second parallel arms.

12. The system of claim 1, wherein the second attachment assembly comprises a flexible material for removably encircling a portion of the physical controller object, wherein the flexible material passes around an external surface of the registrator to thereby removably affix the registrator to the physical controller object.

13. The system of claim 12, wherein the flexible material of the second attachment assembly comprises one or more of a fabric belt, a Velcro strap, and a webbing.

14. The system of claim 1, wherein the second attachment assembly comprises a double-sided adhesive affixing the registrator to the physical controller object.

15. The system of claim 1, wherein the adjustable receiving portion of the fixator is adjustable to receive display devices having varying lengths and varying widths and is further adjustable to move the received display device into one or more different relative orientations with respect to the physical controller object.

16. The system of claim 15, wherein the fixator further comprises an adjustment knob, separate from the adjustable receiving portion, for rotating and adjusting an orientation of the display device to a desired fixed relative position on the physical controller object.

17. The system of claim 1, wherein the registrator includes a wired connection to the actuation registration device.

18. The system of claim 17, wherein the registrator further includes a wire organizer integrated into a housing of the registrator, such that one or more wires of the wired connection or the actuation registration device can be stored in the wire organizer

19. The system of claim 1, wherein the registrator further includes a wireless receiver, such that the registrator receives one or more wireless signals from by one or more actuation sensors and determines that the actuation registration device has been moved within a predetermined distance of the registrator based at least in part on the received wireless signals.

20. The system of claim 19, wherein one or more of the registrator wireless transmitter and the registrator wireless receiver implement Bluetooth or Wi-Fi Direct.
